(19) United States
(12) Patent Application Publication
(10) Pub. No.: US 2007/0234631 A1
(43) Pub. Date: Oct. 11, 2007

(54) On-Person Fishing Pole Holder

(76) Inventor: Thomas E. Parkison, Vichy, MO (US)

Correspondence Address: ADVANTIA LAW GROUP, 9035 SOUTH 1300 EAST, SUITE 200, SANDY, UT, 84094, US

(21) Appl. No.: 11/279,232

(22) Filed: Apr. 10, 2006

(51) Int. Cl. A01K 97/10

(52) U.S. Cl. 43/21.2; 224/922

(57) ABSTRACT

A novel apparatus for holding a fishing pole at least includes: a water-resistant holster member adapted to receive the handle end of a fishing pole; a first securing strap adapted to be coupled to the holster member and coupled around the waist of a user; and at least a second securing strap adapted to be coupled to the holster member and coupled to at least a second region of the user's body. The fishing pole is adapted to be held in place to allow the hands of the user to be freed for other tasks.

### BACKGROUND OF THE INVENTION

1. Field of the Invention

The present invention relates to fishing equipment in general, and to accessories for holding and securing fishing poles in particular.

2. Description of the Related Art

Those who engage in fishing—whether as a hobby or in pursuit of a livelihood—appreciate that the necessity of using one, and often two hands to hold a fishing pole prohibits them from pursing other tasks while the pole is being actively used. One prior art approach to freeing a fisherman's hands is to place the fishing pole on a ground supported mount. However, this approach often does not secure the pole adequately for the line tension that an ensnared fish may transmit to the pole. A better approach is to use ground mounts that secure the pole around its periphery.

Ground mounted fishing poles have several drawbacks, including a lack of proximity between the pole and the fisherman when the fisherman wanders from the pole situs. This approach would not therefore be suitable for fly fishing, for example.

Other prior art approaches that mount to the shoulders or the like are disclosed, for example, in the following U.S. patent application Nos.: 6,129,251; 4,529,112; 3,874,573; 2,298,694; and Design 328,186. These approaches are more extravagant than desirable, and some cause the fishing pole to rest to high for comfort. What is therefore needed is an apparatus for conveniently securing a fishing pole to the person of a fisherman to free the fisherman's hands, at a convenient height and reach position, and which is inexpensive.

### SUMMARY OF THE INVENTION

The present invention has been developed in response to the present state of the art, and in particular, in response to the problems and needs in the art that have not yet been fully solved. Accordingly, the present invention has been developed to provide a novel apparatus for holding a fishing pole that at least includes: a water-resistant holster member adapted to receive the handle end of a fishing pole; a first securing strap adapted to be coupled to the holster member and coupled around the waist of a user; and at least a second securing strap adapted to be coupled to the holster member and coupled to at least a second region of the user's body. The fishing pole is adapted to be held in place to allow the hands of the user to be freed for other tasks.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front view of a first embodiment the present-inventive fishing pole holding apparatus capable of securing a fishing pole next to the body (via the waist and thigh) of a user to free the hands of the user for other activities during fishing;

FIG. 2 shows a side view from the right of the fishing pole holding apparatus of FIG. 1, and a side view from the left of the fishing pole holding apparatus of FIG. 1; and

FIG. 3 is a rear view of a second embodiment the present-inventive fishing pole holding apparatus capable of securing a fishing pole next to the body (via the waist and shoulders) of a user to free the hands of the user for other activities during fishing.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

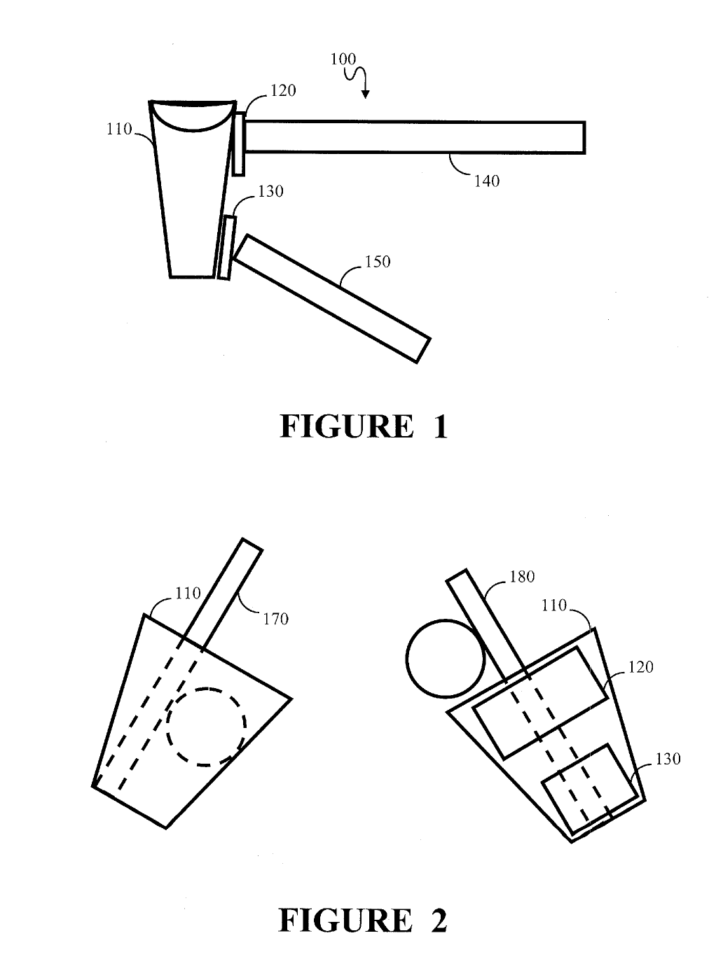

FIG. 1 illustrates a first version of the present-inventive apparatus 100 for securing a fishing pole next to the person of a fisherman. The apparatus 100 contains a holster member or holster 110 constructed of suitable water-resistant material with the structural integrity to support the handle end of a fishing pole. In the preferred embodiment, the holster is capable of accepting both a conventional (long handled) fishing pole, and a fly-fishing pole. The version of the apparatus in FIG. 1 includes an adjustable waist strap 140 secured to the holster by a coupler or fastener 120. A second adjustable strap 150 secures the holster at its bottom to the fisherman's thigh via a second coupler 130.

The couplers 120 and 130 may have many variations, including slotted components for accepting the straps which are permanently secured to the holster. According to one embodiment, the couplers 120 and 130 include buckles. According to another embodiment, the couplers 120 and 130 may also contain hook-and-loop type couplers such as those sold under the tradename Velcro®, with surfaces to be mated to both the straps and the bolster, as will be appreciated by those skilled in the art to which the present invention pertains. In yet another embodiment, the couplers 120 and 130 include at least two means of coupling, such as, for example, Velcro® hook and loop surfaces, as well as buckles.

FIG. 2 shows a right side view of a holster 110 with a fly fishing type fishing rod 170 secured on the left, and a left side view of a holster 110 with a conventional fishing rod 180 secured on the right.

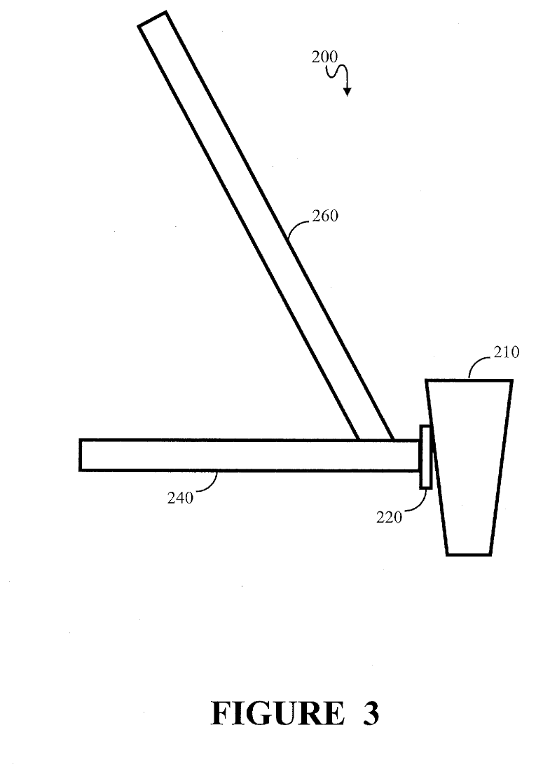

In addition to the waist and thigh mounting approach of the present invention, the holster can also be secured to the body via a waist and shoulder strap combination 200 shown in FIG. 3. In the embodiment of FIG. 3, a holster 210 is secured to a waist strap 240 via a coupler 220. A cross-chest strap 260 secured directly to the waist strap is adapted to receive the shoulder of the fisherman. Both straps may be adjusted in length to provide a custom and secure fit.

The present-inventive apparatus for the on-person securing of fishing poles can be used on either the right hand side or the left hand side, without any additional components.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention. For example, the couplers 120 and 130 may include any means of connecting known in the art.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1-18. (canceled)

19. An apparatus for holding a fishing pole, comprising:
a water-resistant holster member configured to receive and secure the handle end of a fishing pole to allow the hands of a user to be freed for other tasks;
a first securing strap coupled to a first coupler of the holster member and coupleable around the waist of the user; and
at least a second securing strap coupled to a second coupler of the holster member and coupleable to at least a second region of the user's body;
wherein the first coupler and the second coupler each include hook and loop and are operatively coupled between said holder member and said first and second securing straps, respectively.

20. (canceled)

21. The apparatus of claim 19, wherein said second securing strap is coupleable to a user's lower extremity.

22. The apparatus of claim 19, wherein said second securing strap is coupleable to a user's shoulders.

23. (canceled)

24. The apparatus of claim 19, wherein said holster member is configured to accept conventional fishing poles and fly-fishing poles.

25. An apparatus for holding a fishing pole, consisting essentially of:
a water-resistant holster member configured to receive and secure the handle end of a fishing pole to allow the hands of a user to be freed for other tasks;
a first securing strap coupled to a first coupler of the holster member and coupleable around the waist of the user; and
a second securing strap coupled to a second coupler of the holster member and coupleable to at least a second region of the user's body;
wherein the first coupler and the second coupler each include hook and loop and are operatively coupled between said holder member and said first and second securing straps, respectively.

26. (canceled)

27. The apparatus of claim 25, wherein said second securing strap is coupleable to a user's lower extremity.

28. The apparatus of claim 25, wherein said second securing strap is coupleable to a user's shoulders.

29. (canceled)

30. The apparatus of claim 25, wherein said holster member is configured to accept conventional fishing poles and fly-fishing poles.

31. An apparatus for holding a fishing pole, comprising:
a water-resistant holster member configured to receive and secure the handle end of a fishing pole to allow the hands of a user to be freed for other tasks;
a first securing strap coupled to a first coupler of the holster member and coupleable around the waist of the user; and
at least a second securing strap coupled to a second coupler of the holster member and coupleable to at least a second region of the user's body;
wherein the first coupler and the second coupler each include a buckle and are operatively coupled between said holder member and said first and second securing straps, respectively.

32. The apparatus of claim 19, wherein said second securing strap is coupleable to a user's lower extremity.

33. The apparatus of claim 19, wherein said second securing strap is coupleable to a user's shoulders.

34. The apparatus of claim 19, wherein said holster member is configured to accept conventional fishing poles and fly-fishing poles.
